(19) United States
(12) Patent Application Publication
(10) Pub. No.: US 2020/0109803 A1
(43) Pub. Date: Apr. 9, 2020

(54) FLANGE ASSEMBLY AND METHOD OF INSTALLATION

(71) Applicant: Garhett Rose, Soss, OK (US)

(72) Inventor: Garhett Rose, Soss, OK (US)

(21) Appl. No.: 16/153,025

(22) Filed: Oct. 5, 2018

(51) Int. Cl. F16L 23/036

(52) U.S. Cl. CPC F16L 23/036; F16L 23/162

(57) ABSTRACT

A flange, flange assembly and method of installation is disclosed. In some embodiments the flange, flange assembly and method of installation includes a plurality of circular openings for insertion of a connector therethrough. Wherein one or more of the circular openings has a polygon shaped recess positioned around the circular opening. The polygon shaped recess having a dimension greater than the dimension of the circular opening, such that a means for securing the connector can be positioned within the polygon shaped recess. The polygon shaped recess configured to prevent the means for securing the connector from rotating while positioned within the polygon shaped recess.

### FIELD OF INVENTION

The invention is in the technical field of flanges for use in connecting tubular segments to form a continuous passageway therethrough. In some embodiments, the segments are pipe and the invention is used to form a continuous pipeline for use in the oil and gas industry to transport pressurized fluids and gases, such as water, slurry, petroleum, oil, natural gas and the like. As will be appreciated by one of ordinary skill in the art, the segments used with the invention may be constructed from a variety of materials and may be used to transport a variety of goods, equipment and materials, including but not limited to, segments constructed from metals, plastics and other materials and segments used for transporting fluids and, gases or holding and securing wires, cables and the like, for example. The invention pertains generally to an improved flange assembly and improved method of installation of said flange assembly as described and claimed herein.

### BACKGROUND

Traditional flange assemblies generally include a projecting radial collar having a central borehole for fluid flow therethrough. The projecting radial collar includes a plurality of bolt holes to provide a means of attachment to various components having a similar fitting. The projecting radial collar may also include a circular ring positioned or embedded thereon and configured to function as a seal when a second identical traditional flange assembly is bolted to the traditional flange assembly thereby permitting fluid, gas or other goods or equipment to be transported therethrough.

To connect a first traditional flange assembly to a second traditional flange assembly sufficient to create a seal for pressurized fluid or gas to flow therethrough, bolts are threaded through the bolt holes of the first traditional flange assembly and through the bolt holes of the second traditional flange assembly. The bolts are then secured thereto with nuts, which are typically tightened by one or more persons using both hands and a tool, such as a torque wrench (manual or hydraulic), for example. Generally, a first person holds a first end of the bolt in place with a torque wrench while a second person tightens the nut around the opposite end of the bolt using another torque wrench. This process is then repeated with each bolt and each nut, usually in a circular fashion, around the projecting radial collar, until all of the bolts and all of the nuts are secured thereto.

Likewise, to disconnect a first traditional flange assembly to a second traditional flange assembly, one person holds a first end of the bolt in place with a torque wrench while another person loosens the nut around the opposite end of the bolt using another torque wrench. This process is then repeated with each bolt and each nut, usually in a circular fashion, around the projecting radial collar, until all of the bolts and all of the nuts are loosened and removed therefrom.

Unfortunately however, such traditional flange assemblies are often difficult and extremely dangerous for persons to properly connect and disconnect. While if is possible for one person to connect and disconnect a traditional flange assembly, it is generally not recommended. Because the bolt holes of traditional flange assemblies are configured so that the nuts attached thereto rest flush against the outer surface of the projecting radial collar, two people are typically required to safely secure the nuts to a traditional flange assembly. One person to hold a first end of the bolt in place with a torque wrench while another person loosens or tightens the nut around the opposite end of the bolt using another torque wrench. Especially when the traditional flange assembly is intended to be used with the transport of high pressure fluid or gas or toxic or dangerous chemicals or wires. If the traditional flange assembly is not properly connected or disconnected, for example, the introduction of a high pressure fluid or gas can cause the traditional flange assembly and the bolts and nuts attached thereto to quickly and violently explode, causing death or injury to persons nearby, damage to property and causing the fluid or gas being transported therethrough to spill out into the environment.

To improve the safety and efficiency of traditional flanges, it would be advantageous to provide an improved flange, flange assembly and method of installation. The improved flange having a projecting radial collar and a plurality of circular openings for insertion of a connector, such as a bolt, therethrough, wherein one or more of the circular openings has a polygon shaped recess positioned around the circular opening. The polygon shaped recess having a dimension greater than the dimension of the circular opening, such that a means for securing the connector, such as a nut, can be positioned within the polygon shaped recess so that the means for securing the connector partially extends out from the front surface of the projecting radial collar. Thereby preventing the means for securing the connector from rotating while positioned within the polygon shaped recess. In this way, the flange itself provides a mechanism for preventing a nut from rotating when a person tightens or loosens the nut around the other end of the bolt. Thus, permitting a single person or more than one person to more efficiently and safely secure the nut to the bolt and connect or disconnect the flange. It is to such an improved flange, flange assembly, and methods for using thereof that exemplary embodiments of the inventive concepts disclosed and claimed herein are directed.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a cross sectional, side view an embodiment of a flange according to the inventive concepts disclosed herein.

FIG. 2 is a plan view of the flange shown in FIG. 1 taken along line 2-2 of FIG. 1. according to the inventive concepts disclosed herein.

FIG. 3 is a plan view of the flange shown in FIG. 1 taken along line 3-3 of FIG. 1 according to the inventive concepts disclosed herein.

FIG. 4 is a cross-sectional side view of an embodiment of a flange assembly according to the inventive concepts disclosed herein.

FIG. 5 is a diagram depicting an embodiment of a method of connecting an embodiment of a first flange to an embodiment of a second flange according to the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a system, assembly, method, process, article, or apparatus that comprises a list of elements or steps is not necessarily limited to only those elements or steps but may include other elements and steps not expressly listed.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

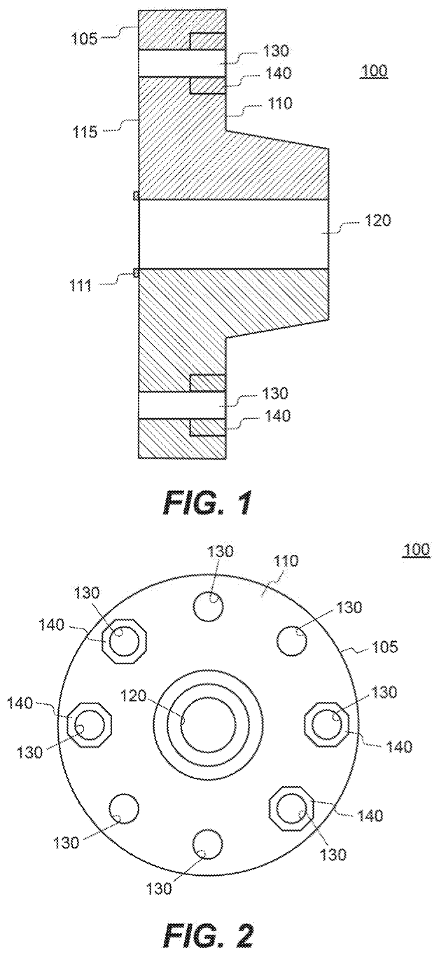

Referring now to FIGS. 1-3, shown therein is an exemplary embodiment of a flange (100) in accordance with the inventive concepts disclosed herein. The flange (100) includes a projecting radial collar (105) having a front surface (110), a back surface (115) and a central borehole (120) extending therethrough. The projecting radial collar (105) having a plurality of circular openings (130) for insertion of a connector (135) therethrough. Wherein one or more of the circular openings (130) has a polygon shaped recess (140) positioned around the circular opening (130). The polygon shaped recess (140) having a dimension greater than the dimension of the circular opening (130), such that a means for curing (145) the connector (135) can be positioned within the polygon shaped recess (140). The means for securing (145) the connector (135) partially extends out from the front surface (110) of the projecting radial collar (105) when the means for securing (145) the connector (135) is connected to the connector (135) extending through the circular opening (130). Thereby preventing the means for securing (145) the connector (135) from rotating while positioned within the polygon shaped recess (140).

Referring now to FIG. 1, shown therein is a cross sectional side view of an embodiment of a flange (100) according to the inventive concepts disclosed herein. The flange (100) includes a projecting radial collar (105) having a front surface (110), a back surface (115) and a central borehole (120) extending therethrough. The projecting radial collar (105) having a plurality of circular openings (130) for insertion of a connector (135) therethrough. Wherein one or more of the circular openings (130) has a polygon shaped recess (140) positioned around the circular opening (130).

The flange (100) may be constructed from any material sufficient to hold or transport the desired fluid, gas or material through the borehole (120) and sufficient to permit the flange (100) to be connected and disconnected to other flanges and to other pipe or other material and equipment. For example the flange (100) may be constructed from metals, alloys, steel, titanium, non-metals, carbon fiber, plastics, polymers, resins, ceramics, composite materials, combinations thereof and the like.

The projecting radial collar (105) of the flange (100) is shown as having a substantially circular shape. However, it should be understood that that the projecting radial collar (100) may have any desired shape, including but not limited to circular, square, rectangular, triangular or any other desired shape sufficient to permit the flange (100) to be connected and disconnected to other flanges known in the art and to other pipe or other material and equipment and to sufficient to permit fluid, gas and other material to be held or transported through the borehole (120).

The flange (100) has a front surface (110), a back surface (115) and a central borehole (120) extending therethrough. The front surface (110) of the flange (100) is configured to be the portion of the flange (100) that faces the outside when the flange (100) is connected to another flange (100) or another flange pipe or piece of equipment known in the art, for example. The back surface (115) of the flange (100) is configured to be the portion of the flange (100) that faces the inside when the flange (100) is connected to another flange (100) or another flange, pipe or piece of equipment known in the art, for example.

As shown in FIG. 1, in some embodiments the back surface (115) of the flange (100) may also include a ring (111), configured to be used to create a seal when the flange (100) is connected to another flange (100) or connected to another flange, pipe or piece of equipment known in the art. The ring (111) is configured to permit fluid, gas or other material to be held or transported through the borehole (120), including but not limited to pressurized fluids and gases.

The projecting radial collar (105) also includes a plurality of circular openings (130) for insertion of a connector (135) therethrough. As will be appreciated by persons of ordinary skill in the art, each circular opening (130) may be sized and dimensioned to accommodate a variety of connectors (135). For example, each circular openings (130) may be configured to accommodate large connectors (135) for use with oil and gas pipelines. Alternatively, the circular openings (130) may be configured for use with small pipes, flanges and other equipment.

Further, while the openings (130) are shown and generally described herein as being circular, it should be understood that the openings (130) may be configured to have a variety of shapes sufficient to fit a particular connector (135). For example, the openings (130) could be rectangular, square, or triangular. It being understood, however, that the shape of the opening (130) is required to be of a different shape than the shape of the recess (140). For example, if the opening (130) is rectangular in shape, the recess (140) could be any shape except rectangular. The contrasting shape of the opening (130) and the recess (140) permits the flange (100) to lock one or more connector (135) in place.

One or more of the circular openings (30) has a polygon shaped recess (140) positioned around the circular opening (130). The polygon shaped recess (140) configured to prevent the means for securing (145) the connector (135) from rotating while positioned within the polygon shaped recess (140). The recess (140) may be configured to have a variety of shapes sufficient to fit a particular connector (135). For example, the recess (140) could be rectangular, square, or triangular. It being understood however, that the shape of the recess (140) is required to be of a different shape than the shape of the opening (130). For example, if the recess (130) has a hexagon shape, the opening (130) could be any shape except a hexagon. The contrasting shape of the recess (140) and the opening (130) permits the flange (100) to lock one or more connector (135) in place.

The connector (135) may be any desired connector known in the art. For example, the connector (135) may be a bolt, pin, rod screw, combinations thereof and the like. Further, the means for securing (145) the connector (135) may be any desired means for securing the connector (135) known in the art. For example, the means for securing (145) may be a nut, cap, lid, combinations thereof and the like.

In some embodiments the flange (100) is a pipe flange configured for the transport of pressurized fluids and gases. Further, in some embodiments, the connector (135) is a bolt and the means for securing (145) the connector (135) is a nut for example.

Referring now to FIG. 2, shown therein is a plan view of the flange (100) shown in FIG. 1 taken along line 2-2 of FIG. 1 according to the inventive concepts disclosed herein. As shown therein, the front surface (110) of the flange (100) has a central borehole (120) extending therethrough. The projecting radial collar (105) having a plurality of circular openings (130) for insertion of a connector (135) therethrough. The front surface (110) of the projecting radial collar (105) is configured to be the portion of the flange (100) that faces the outside when the flange (100) is connected to another flange (100) or another flange, pipe or piece of equipment known in the art, for example.

As shown therein, one or more of the circular openings (130) has a polygon shaped recess (140) positioned around the circular opening (130). The polygon shaped recess (140) having a dimension greater than the dimension of the circular opening (130). In use, a means for securing (145) the connector (135) can be positioned within the polygon shaped recess (140) so that the means for securing (145) the connector (135) partially extends out from the front surface (110) of the projecting radial collar (105) when the means for securing (145 the connector (135) is connected to the connector (135). Thereby preventing the means for securing (145) the connector (135) from rotating while positioned within the polygon shaped recess (140).

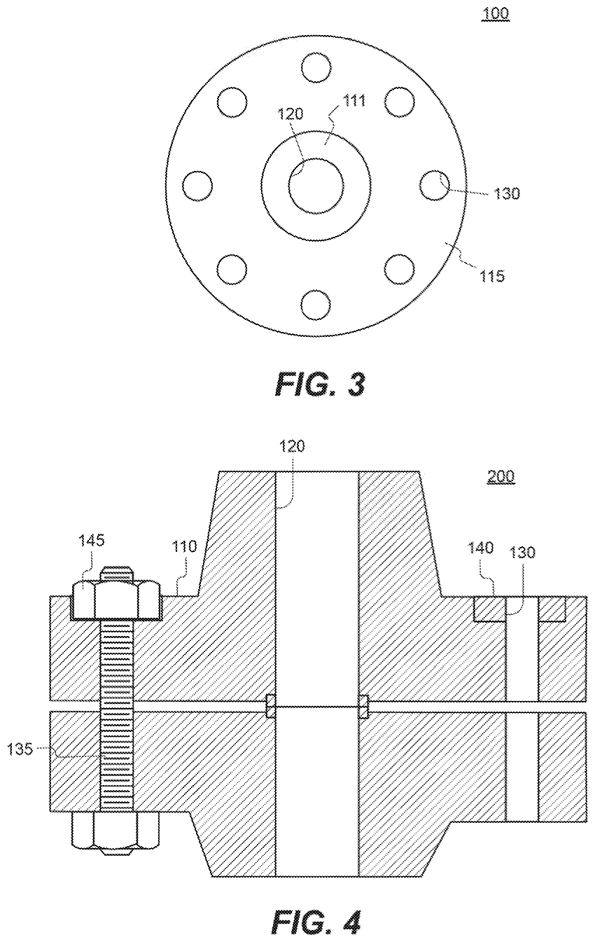

Referring now to FIG. 3, shown therein is a plan view of the flange (100) shown in FIG. 1 taken along line 3-3 of FIG. 1 according to the inventive concepts disclosed herein. As shown therein, the back surface (115) of the flange (100) includes a plurality of circular openings (130) and a borehole (120) extending between the back surface (115) and the front surface (110) (show in FIGS. 1 and 2). Also shown in FIG. 3 is the ring (111). The ring (111) configured to be used to create a seal when the flange (100) is connected to another flange (100) or connected to another flange, pipe or piece of equipment known in the art. The ring (111) is configured to permit fluid, gas or other material to be held or transported through the borehole (120), including but not limited to pressurized fluids and gases for example. The back surface (115) of the flange (100) is configured to be the portion of the flange (100) that faces the inside when the flange (100) is connected to another flange (100) or another flange, pipe or piece of equipment known in the art, for example.

Referring now to FIG. 4, shown therein is an exemplary embodiment of a flange assembly (200) in accordance with the inventive concepts disclosed herein. The flange assembly (200) includes a first flange (100). The first flange (100) including a projecting radial collar (105) having a front surface (110), a back surface (115) and a central borehole (120) extending therethrough. The projecting radial collar (105) having a plurality of circular openings (130) for insertion of connectors (135) therethrough. Wherein one or more of the circular openings (130) has a polygon shaped recess (140) positioned around the circular opening (130). The polygon shaped recess (140) having a dimension greater than the dimension of the circular opening (130). Such that a means for securing (145) the connector (135) can be positioned within the polygon shaped recess (140). So that the means for securing (145) the connector (135) partially extends out from the front surface (110) of the projecting radial collar (105) when the means for securing (145) the connector (135) is secured to the connector (135) extending through the circular opening (130). Thereby preventing the means for securing (145) the connector (135) from rotating while positioned within the polygon shaped recess (140).

The flange assembly (200) further includes a second flange (100) connected to the first flange (100). The second flange (100) includes a projecting radial collar (105) having a front surface (110), a back surface (115) and a central borehole (120) extending therethrough. The projecting radial collar (105) having a plurality of circular openings (130) for insertion of connectors (135) therethrough. Wherein one or more of the circular openings (130) has a polygon shaped recess (140) positioned around the circular opening (130). The polygon shaped recess (140) having a dimension greater than the dimension of the circular opening (130). Such that a means for securing (145) the connector (135) can be positioned within the polygon shaped recess (140). So that the means for securing (145) the connector (135) partially extends out from the front surface (110) of the projecting radial collar (105) when the means for securing (145) the connector (135) is secured to the connector (135) extending through the circular opening (130). Thereby preventing the means for securing (145) the connector (135) from rotating while positioned within the polygon shaped recess (140). The flange assembly (200) further includes a plurality of connectors (135) and a plurality of means for securing (145). The connectors (135) for detachably connecting the first flange (100) to the second flange (100).

As will be appreciated by persons of ordinary skill in the art, each circular opening (130) may be sized and dimensioned to accommodate a variety of connectors (135). For example, each circular openings (130) may be configured to accommodate large connectors (135) for use with oil and gas pipelines. Alternatively, the circular openings (130) may be configured for use with small pipes, flanges and other equipment.

Further, while the openings (130) are shown and generally described herein as being circular, it should be understood that the openings (130) may be configured to have a variety of shapes sufficient to fit a particular connector (135). For example, the openings (130) could be rectangular, square, or triangular. It being understood, however, that the shape of the opening (130) is required to be of a different shape than the shape of the recess (140). For example, if the opening (130) is rectangular in shape, the recess (140) could be any shape except rectangular. The contrasting shape of the opening (130) and the recess (140) permits the flange (100) to lock one or more connector (135) in place.

One or more of the circular openings (130) has a polygon shaped recess (140) positioned around the circular opening (130). The polygon shaped recess (140) configured to prevent the means for securing (145) the connector (135) from rotating while positioned within the polygon shaped recess (140). The recess (140) may be configured to have a variety of shapes sufficient to fit a particular connector (135). For example, the recess (140) could be rectangular, square, or triangular. It being understood, however, that the shape of the recess (140) is required to be of a different shape than the shape of the opening (130). For example, if the recess (130) has a hexagon shape, the opening (130) could be any shape except a hexagon. The contrasting shape of the recess (140) and the opening (130) permits the flange (100) to lock one or more connector (135) in place.

The connector (135) may be any desired connector known in the art. For example, the connector (135) may be a bolt, pin, rod, screw, combinations thereof and the like. Further, the means for securing (145) the connector (135) may be any desired means for securing the connector (135) known in the art. For example, the means for securing (145) may be a nut, cap, lid, combinations thereof and the like.

In some embodiments of the flange assembly (200), the first flange (100) is a pipe flange configured for the transport of pressurized fluids and gases. Further, in some embodiments of the flange assembly (200), the second flange (100) is a pipe flange configured for the transport of pressurized fluids and gases. In some embodiments of the flange assembly (200), the connector (135) is a bolt. In some embodiments of the flange assembly (200), the means for securing (145) the connector (135) is a nut.

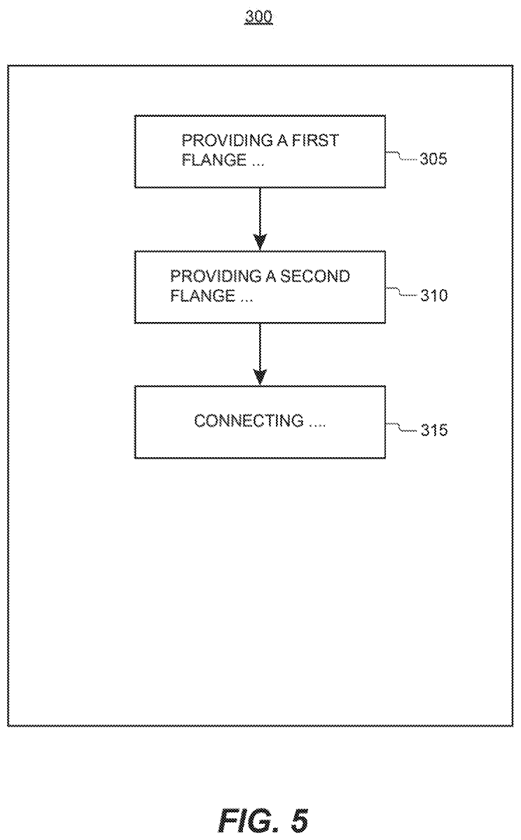

Referring now to FIG. 5, shown therein is an exemplary embodiment of a method (300) of connecting an embodiment of a first flange (100) to a second flange (100) in accordance with the inventive concepts disclosed herein. The method (300) including the steps of: providing (305) a first flange (100) having a projecting radial collar (105) having a front surface (110), a back surface (115) and a central borehole (120) extending therethrough. The projecting radial collar (105) having a plurality of circular openings (130) for insertion of connectors (135) therethrough. Wherein one or more of the circular openings (130) has a polygon shaped recess (140) positioned around the circular opening (130). The polygon shaped recess (140) having a dimension greater than the dimension of the circular opening (130). Such that a means for securing (145) the connector (135) can be positioned within the polygon shaped recess (140). So that the means for securing (145) the connector (135) partially extends out from the front surface (110) of the projecting radial collar (105) when the means for securing (145) the connector (135) is connected to the connector (135) extending through the circular opening (130). Thereby preventing the means for securing (145) the connector (135) from rotating while positioned within the polygon shaped recess (140).

The method (300) further including the step of: providing (310) a second flange (100). The second flange (100) having a projecting radial collar (105) having a front surface (110), a back surface (115) and a central borehole (120) extending therethrough. The projecting radial collar (105) having a plurality of circular openings (130) for insertion of connectors (135) therethrough. Wherein one or more of the circular openings (130) has a polygon shaped recess (140) positioned around the circular opening (130). The polygon shaped recess (140) having a dimension greater than the dimension of the circular opening (130). Such that a means for securing (145) the connector (135) can be positioned within the polygon shaped recess (140) so that the means for securing (145) the connector (135) partially extends out from the front surface (110) of the projecting radial collar (105) when the means for securing (145) the connector (135) is connected to the connector (135) extending through the circular opening (130). Thereby preventing the means for securing (145) the connector (135) from rotating while positioned within the polygon shaped recess (140).

The method (300) further including the step of: connecting (315) the first flange (100) to the second flange (100) by threading one or more connectors (135) through the circular openings (130) of the first flange (100) and the circular openings (130) of the second flange (100) and securing a means for securing (145) a connector (135) thereto. Such that each means for securing (145) a connector (135) is positioned within the polygon shaped recess (140) of the first flange (100) and the polygon shaped recess (140) of the second flange (100) and extends out partially from the front surface (110) of the projecting radial collar (105) of the first flange (100) and the projecting radial collar (105) of the second flange (100).

In operation, one or more persons may connect the first flange (100) to the second flange (100) as follows, for example. One person may hold a first end of a connector (135), such as a bolt, in place with a torque wrench while another person loosens or tightens the means for securing (145), such as a nut, around the opposite end of the connector (135) using another torque wrench. Alternatively, one person may use one hand to hold a first end of a connector (135), such as a bolt, in place with a torque wrench while using the other hand to loosen or tighten the means for securing (145), such as a nut, around the opposite end of the connector (135) using a second torque wrench. In this way, one person may safely connect and disconnect the flange (100) to another flange (100), other flanges, equipment and pipe, for example.

Because the polygon shaped recess (140) has a dimension greater than the dimension of the circular opening (130), the means for securing (145) the connector (135) partially extends out from the front surface (110) of the projecting radial collar (105). Thereby preventing the means for securing (145 the connector (135) from rotating while positioned within the polygon shaped recess (140). In this way, the flange (100) itself provides a mechanism for preventing a nut from rotating when a person tightens or loosens the nut around the other end of the bolt. Thus, permitting a single person or more than one person to more efficiently and safely secure the nut to the bolt and connect or disconnect the flange.

In some embodiments of the method (300), the first flange (100) is a pipe flange configured for the transport of pressurized fluids and gases. In some embodiments of the method (300), the second flange (100) is a pipe flange configured for the transport of pressurized fluids and gases. Further, in some embodiments of the method (300), the connector (135) is a bolt and the means for securing (145) the connector (135) is a nut for example.

It is to be appreciated that embodiments of the flange and flange assembly may be installed and used under a variety of different conditions and for the transportation or storage of a variety of different fluids and goods and materials. Further, embodiments of the flange and flange assembly may be shipped fully assembled, fully or partially disassembled as will be readily appreciated by persons of ordinary skill in the art.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure it will be understood that numerous changes may be made which will readily suggest themselves to those skilled in the art and which are accomplished within the broad scope of the inventive concepts disclosed herein and defined by the appended claims.

What is claimed is:

1. A flange comprising: a projecting radial collar having a front surface, a back surface and a central borehole extending therethrough, the projecting radial collar having a plurality of circular openings for insertion of a connector therethrough, wherein one or more of the circular openings has a polygon shaped recess positioned around the circular opening, the polygon shaped recess having a dimension greater than the dimension of the circular opening, such that a means for securing the connector can be positioned within the polygon shaped recess so that the means for securing the connector partially extends out from the front surface of the projecting radial collar when the means for securing the connector is connected to the connector extending through the circular opening, thereby preventing the means for securing the connector from rotating while positioned within the polygon shaped recess.

2. The flange of claim 1, wherein the flange is a pipe flange configured for the transport of pressurized fluids and gases.

3. The flange of claim 1, wherein the connector is a bolt.

4. The flange of claim 1, wherein the means for securing the connector is a nut.

5. A flange assembly comprising:
a first flange, the first flange comprising a projecting radial collar having a front surface, a back surface and a central borehole extending therethrough, the projecting radial collar having a plurality of circular openings for insertion of connectors therethrough, wherein one or more of the circular openings has a polygon shaped recess positioned around the circular opening, the polygon shaped recess having a dimension greater than the dimension of the circular opening, such that a means for securing the connector can be positioned within the polygon shaped recess so that the means for securing the connector partially extends out from the front surface of the projecting radial collar when the means for securing the connector is secured to the connector extending through the circular opening, thereby preventing the means for securing the connector from rotating while positioned within the polygon shaped recess;
a second flange connected to the first flange, the second flange comprising a projecting radial collar having a front surface, a back surface and a central borehole extending therethrough, the projecting radial collar having a plurality of circular openings for insertion of connectors therethrough, wherein one or more of the circular openings has a polygon shaped recess positioned around the circular opening, the polygon shaped recess having a dimension greater than the dimension of the circular opening, such that a means for securing the connector can be positioned within the polygon shaped recess so that the means for securing the connector partially extends out from the front surface of the projecting radial collar when the means for securing the connector is secured to the connector extending through the circular opening, thereby preventing the means for securing the connector from rotating while positioned within the polygon shaped recess; and
a plurality of connectors and a plurality of means for securing the connectors for detachably connecting the first flange to the second flange.

6. The flange assembly of claim 5, wherein the first flange is a pipe flange configured for the transport of pressurized fluids and gases.

7. The flange assembly of claim 5, wherein the second flange is a pipe flange configured for the transport of pressurized fluids and gases.

8. The flange assembly of claim 5, wherein the connector is bolt.

9. The flange assembly of claim 5, wherein the means or securing the connectors a nut.

10. A method of connecting a first flange to a second flange, the method comprising the steps of:
providing a first flange having a projecting radial collar having a front surface, a back surface and a central borehole extending therethrough, the projecting radial collar having a plurality of circular openings for insertion of connectors therethrough, wherein one or more of the circular openings has a polygon shaped recess positioned around the circular opening, the polygon shaped recess having a dimension greater than the dimension of the circular opening, such that a means for securing the connector can be positioned within the polygon shaped recess so that the means for securing the connector partially extends out from the front surface of the projecting radial collar when the means for securing the connector is connected to the connector extending through the circular opening, thereby preventing the means for securing the connector from rotating while positioned within the polygon shaped recess;
providing a second flange, the second flange having a projecting radial collar having a front surface, a back surface and a central borehole extending therethrough, the projecting radial collar having a plurality of circular openings for insertion of connectors therethrough, wherein one or more of the circular openings has a polygon shaped recess positioned around the circular opening, the polygon shaped recess having a dimension greater than the dimension of the circular opening, such that a means for securing the connector can be positioned within the polygon shaped recess so that the means for securing the connector partially extends out from the front surface of the projecting radial collar when the means for securing the connector is connected to a bolt extending through the circular opening, thereby preventing the means for securing the connector from rotating while positioned within the polygon shaped recess; and
connecting the first flange to the second flange by threading one or more connectors through the circular openings of the first flange and the circular openings of the second flange and securing a means for securing a connector thereto, such that each means for securing a connector is positioned within the polygon shaped recess of the first flange and the polygon shaped recess of the second flange and extends out partially from the front surface of the projecting radial collar of the first flange and the projecting radial collar of the second flange.

11. The method of claim 10, wherein the first flange is a pipe flange configured for the transport of pressurized fluids and gases.

12. The method of claim 10, wherein the second flange is a pipe flange configured for the transport of pressurized fluids and gases.

13. The method of claim 10 wherein the connector is a bolt.

14. The method of claim 10, wherein the means for securing the connector is a nut.
